(19) United States
(12) Patent Application Publication
(10) Pub. No.: US 2012/0089722 A1
(43) Pub. Date: Apr. 12, 2012

(54) METHOD AND SYSTEM FOR DISPLAYING SCHEDULING INFORMATION

(76) Inventor: Markus Enholm, Sollentuna (SE)

(21) Appl. No.: 13/378,204

(22) PCT Filed: Jun. 15, 2010
(86) PCT No.: PCT/SE2010/050671

§ 371 Date: Dec. 14, 2011

(30) Foreign Application Priority Data
Jun. 15, 2009 (SE) 0900812-9

(51) Int. Cl. H04L 29/06

(52) U.S. Cl. 709/223

(57) ABSTRACT

The present invention relates to an information display system for displaying scheduling information regarding utilization of a resource, the information display system comprising at least one display device to be located in proximity to the said resource and including means for displaying scheduling information regarding the said resource, wherein the scheduling of the said resource is controlled by a scheduling server and wherein resource scheduling information is transmitted from the scheduling server over a computer network to the display device for being displayed on a display of the display device. The information display system includes communication means for communication with the said scheduling server by means of a communication protocol by means of which communication protocol the information display system can be automatically authenticated by the said scheduling server, so as to allow communication of scheduling information between the information display system and the scheduling server independent of installation of additional software on the scheduling server.

### FIELD OF THE INVENTION

The present invention relates to scheduling systems, and, in particular, the present invention relates to an information display system in which an electronic display device is utilized for displaying scheduling information according to the preamble of claim 1. The invention also relates to a display device according to claim 13 and a method according to claim 14.

### BACKGROUND OF THE INVENTION

Scheduling of resources, such as, e.g., meeting (conference) rooms, parking lots work spaces etc. is often subject to frustration due to misunderstandings and erroneous bookings, and yet such resources often go unused even while being booked.

Consequently, the scheduling of such resources has been subject to the development of various scheduling systems (a.k.a. booking systems), and today there are various systems for scheduling such resources. These systems, at least with regard to systems of the electronic kind, often have in common that reservations (bookings) are performed by the use of a computer, and the reservation of a resource is then represented, e.g., as a calendar representation in a calendar being specific to the particular resource and which is accessible, and viewable, from user computers.

Systems of this kind, however, have the disadvantage that the reservations are not displayed at the location of the particular resource being reserved, but only by accessing the scheduling system from a computer. This gives rise to ambiguities with regard to whether a resource is actually reserved or not, and can, for example, give rise to undesired situations, e.g. if a person arrives at a meeting room that is empty and thus appears to be free for use, only to subsequently find out that in reality the party having reserved the room is just arriving late.

Therefore, it has been found highly useful to utilize information display systems to present information regarding resource usage where it is needed the most, i.e. at the particular resource itself, such as, e.g., at the entrance of a meeting room. For this reason, systems have been developed in which a display device is being located at the entrance of a room, and which display device is connected to a network so that scheduling information regarding the resource can be communicated over a network to be presented by the display device.

The use of a network connected display device has the advantage that if a person changes a reservation, e.g. using his/her computer, this scheduling change will immediately be reflected by the particular display device that is used to display the current reservations of the resource.

Since the use of such display devices has, among other, the advantage that a person looking for an available resource immediately can see on the display whether the resource is free for use or already being booked, oftentimes, such display devices can also be used to perform an instant reservation if the resource is, in fact, available.

Consequently, the use of network connected display devices has substantial advantages. Such display devices, however, also suffers from various drawbacks. For example, with regard to information display systems of the above kind, it is common that scheduling/calendaring functions are integrated with the e-mail services in a dedicated scheduling server. One example of such scheduling servers is the Microsoft Exchange server. This also means that, when an information display system according to the above is about to be set up, additional applications must be installed on the scheduling server. Although such solutions have advantages from a technical point of view, they also raise concerns among system administrators due to a reluctance to interfere at all with such scheduling servers since nowadays these servers often constitute a critical part of a company's business.

Consequently, there exists a need for an information display system that solves or at least reduces the above mentioned problem.

### SUMMARY OF THE INVENTION

It is an object of the present invention to provide an information display system that at least reduces the above mentioned problem. This object is achieved by an information display system according to the characterizing portion of claim 1, and a display device according to the characterizing portion of claim 13, respectively.

According to the present invention, it is provided an information display system for displaying scheduling information regarding utilization of a resource, the information display system comprising at least one display device to be located in proximity to the said resource and including means for displaying scheduling information regarding the said resource, wherein the scheduling of the said resource is controlled by a scheduling server and wherein resource scheduling information is transmitted from the scheduling server over a computer network to the display device for being displayed on a display of the display device. The information display system includes communication means for communication with the said scheduling server by means of a communication protocol by means of which communication protocol the information display system can be automatically authenticated by the said scheduling server, so as to allow communication of scheduling information between the information display system and the scheduling server independent of installation of additional software on the scheduling server.

This has the advantage that the information display system can be added to an existing network architecture without the requirement of any additional software on the scheduling server, i.e. the communication is independent of such additional software. This has the further advantage that system administrators need not do any changes in the scheduling server other than was it performed during regular use, and also increases the possibility of installing the information display system without causing any undesired disruptions in other parts of the computer network.

Further characteristics of the present invention, and advantages thereof, will be evident from the following detailed description of preferred embodiments and appended drawings, which are given by way of example only, and are not to be construed as limiting in any way.

### BRIEF DESCRIPTION OF THE DRAWINGS

FIG. 1 schematically shows resources for which dedicated display devices are being utilized for displaying scheduling information in a scheduling system.

FIG. 2 schematically shows a network architecture of the scheduling system of FIG. 1.

FIG. 3 schematically shows a display device according to the present invention.

FIG. 4 discloses a schematic representation of the general principle according to the present invention.

FIG. 5 discloses an alternative exemplary embodiment according to the present invention.

### DETAILED DESCRIPTION OF AN EXEMPLARY EMBODIMENT

In the following description and claims the term “scheduling server” is used to represent any server that is responsible for and handling for reservations with regard to a resource.

Further, the term “resource” is used to represent a physical resource that can be reserved for use by a user. Examples of such resources are, in a non-limiting manner, meeting (conference) rooms, parking lots, class rooms (with regard to, e.g. schools), operating rooms (with regard to hospitals), office space etc.

As was mentioned above, efficient scheduling and use of resources such as, e.g., meeting rooms can be facilitated by arranging associated display devices in proximity to the meeting rooms, preferably at the entrances of the meeting rooms. The display device can be used to display relevant meeting information outside the meeting room, and automatically synchronize with a scheduling system so as to ensure that accurate data is presented on the display device.

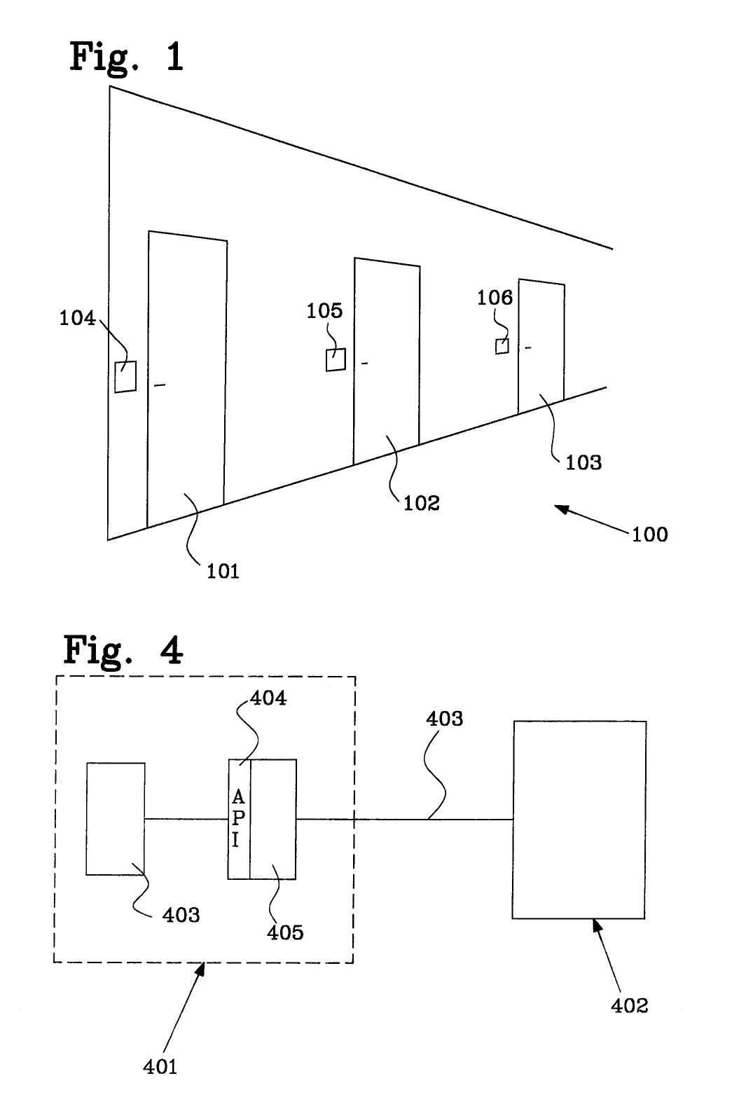

FIG. 1 shows an example of a meeting room area 100 in which the present invention advantageously can be utilized. As can be seen in the figure, the meeting room area comprises three meeting rooms 101-103, each being provided with an associated display device 104-106. The display devices 104-106 are used to display reservations (bookings) of the associated meeting rooms 101-103, respectively.

The display devices 104-106 display selected meeting information outside the meeting rooms 101-103, thereby assisting participants of a meeting to properly locate the particular meeting room in which the meeting is to be held. Apart from displaying information regarding already made reservations, the display device can also be provided with an indicator, such as, e.g. lights (for example, bright red for occupied and green for free) so as to avoid interruption of ongoing meetings or find a meeting room at present being free for reservation and even allow determination of room availability from a distance. The display device can, e.g., be arranged to display reservations for a defined period of time, such as, e.g. the next couple of hours, a full day, all days of the week, etc.

The display device can further be arranged to display the name/identity of the person responsible for the reservation, and/or the subject of the meeting. It is also contemplated that a system administrator can set different settings for different display devices in the system, so that display devices of e.g. conference rooms display the name/identity of the person responsible for the reservation, and possibly subject, while e.g. a display device of a board room can be set to show no information at all, other than that the room has been reserved.

In another exemplary embodiment, the system can be provided with a feature, e.g. to be set by the system administrator, where a reservation is automatically cancelled if a certain time period, e.g. 15 or 30 minutes, after the meeting was to commence has lapsed and it has not been confirmed that the meeting actually has started. This confirmation can, for example, be carried out e.g. by a user pressing/touching an appropriate indication on the display, or automatically by means of suitable input, e.g. from a light and/or motion sensor in the room.

In one embodiment, the display device can provide further functionality so as to, apart from the possibility to check availability, also reserve an available room or extend and/or delete a reservation when the meeting schedule is changed. In one embodiment the display device is provided with a touch screen for providing such functionality by means of a touch screen interface.

In another exemplary embodiment, the display device can be connected to e.g. a relay or other suitable means, so that features such as e.g. lights, ventilation etc. can be turned on/activated at the start of a reservation, or at a suitable time prior to the start of a reservation, by initiation of the display device.

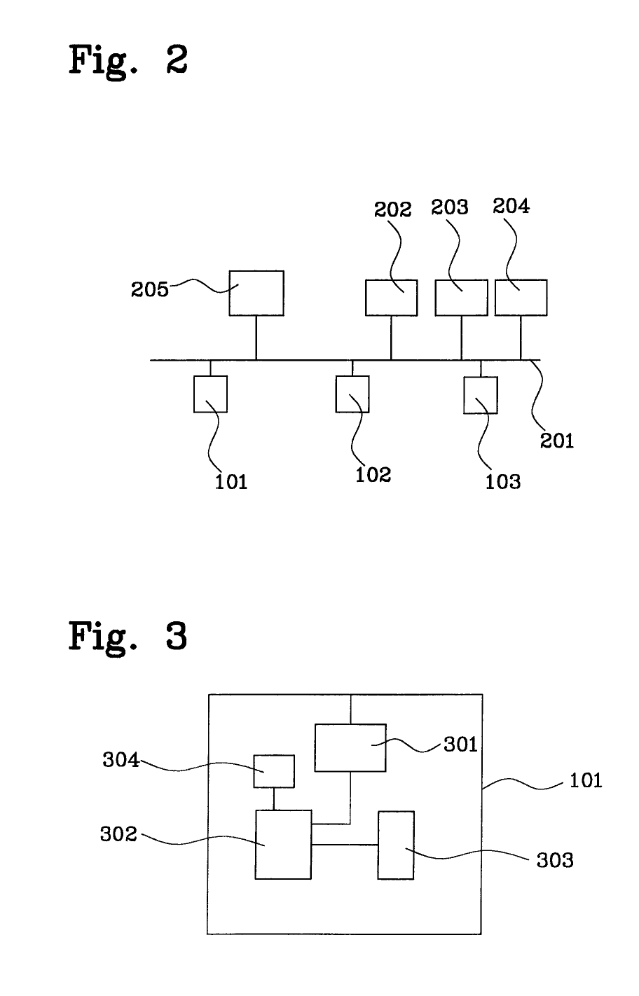

The system according to the present invention will be described more in detail with reference to FIG. 2, which shows the network architecture of the information display system of FIG. 1. The display devices 101-103 are connected to a computer network 201, which can be a computer network of any suitable standard such as, e.g. the Ethernet network standard which is commonly used in office computer networks today.

An exemplary display device 101 is schematically shown in FIG. 3. The display device 101 comprises a network interface 301 for allowing connection to the computer network 201, and a central processing unit 302 such as a Microprocessor or Micro controller for controlling the operation of the display device. The display of the display device can be of any suitable kind, e.g. a Liquid Crystal Display or a LED display. The central processing unit 302 communicates with entities on the computer network 201 via the network interface 301 and further controls data to be displayed on the display of the device 101, e.g. via a video display adapter 303. Operation of the display device 101 can, e.g. be controlled by software stored in a memory 304 connected to the central processing unit 302.

The figure also discloses user computers 202-204, by means of which users of the system can check availability of any of the meeting rooms 101-103, make reservations, update reservations or delete an existing reservation. According to the exemplary embodiment, the user accomplishes the reservations, deletions, etc. by using a conventional Microsoft Outlook calendar system.

Consequently, the user performs meeting room reservation in exactly the same manner as is often used today, i.e. by means of a Microsoft Outlook client in the user computer 202-204, and hence the information display system imposes no requirement for installation of additional software on the user computers 202-204. The Outlook clients in the user computers 202-204 communicates with a scheduling server 205, in this example a Microsoft Exchange Server, via the computer network 201 in a conventional manner. In this exemplary embodiment, the display device according to the present invention is thus connected to an existing Microsoft Exchange Server solution and provides an additional interface which can be used to facilitate overview of existing reservations and also to make reservations and/or extending/ending existing reservations.

Consequently, according to one embodiment of the invention, the reservations are primarily made using the Outlook client, and the display device only provides a complement to the existing resource reservation. As was mentioned above, a main feature of the display device according to the present invention is to provide an overview of reservation status at the location of the actual meeting room, and also to allow a user to make instant reservations should a meeting room be free when the user is present at the display device.

As was also mentioned above, however, there are already existing solutions in which display devices are located e.g. at the entrances of meeting rooms, and substantially provides the functionality of the present invention to the extent that has been described above. These prior art solutions, however, suffers from the drawback that in order to allow communication between the display device and the Exchange server, the exchange server must be adapted for such communication. For example, this can be accomplished by installing a web server service in the physical server containing the Exchange Server. This has the advantages that the web server acts as an interface to the Exchange Server software, and can communicate “internally” with the Exchange Server using an internal Exchange Server protocol, whereas the web server communicates “externally” with the display device(s) which then comprises suitable programming for communication with the web server integrated with the Exchange Server.

Such solutions are capable of providing the desired functionality from a user point-of-view. The solutions of this kind, however, are often met with reluctance among system administrators, mainly due to the fact that the scheduling server, e.g. the Exchange Server, in general, constitutes a critical part of company business and therefore system administrators are very reluctant to any change whatsoever with regard to the software architecture of the scheduling server.

According to the present invention, however, the scheduling server is left completely untouched with regard to architecture/additional software, and the only requirement is, similar to Outlook calendar resources in general, that a user account is set up in Exchange for the particular resource (display device), which preferably consists of a “minimum rights” user account, the only requirement being to be capable of accepting and acknowledging reservations. When a user account is set up in this manner in e.g. the Exchange Server, the user account, with regard to the computer network can be a disabled user account and hence there is no risk for accidental access to sensitive information by means of the display device.

Consequently, the only requirement that the present invention imposes on system administrators is to set up an Exchange Server user account in a manner that the system administrators is used to do regularly, e.g. when setting up an account for a new employee or a new resource.

Instead of, as in the prior art, utilizing a web server technology for the communication between display device and exchange server, the present invention utilizes a protocol, such as an Internet protocol, that can be used for automatic authentication of two communicating parties and which can be utilized to communicate with the scheduling server without requiring any additional scheduling server software. One example of an Internet protocol that fulfils this requirement with regard to Microsoft Exchange Servers, and which can be used to access the Exchange server by applications being located outside the physical server on which the Exchange server software is installed, is the protocol called Web-based Distributed Authoring and Versioning (WebDAV).

The WebDAV protocol provides a set of extensions to the Hypertext Transfer Protocol (HTTP). The inventor of the present invention has realized that WebDAV is further a protocol that can be used to access and communicate with an Exchange server from an external device such as the display device according to the present invention.

The use of WebDAV thus allows that clients (display devices) can communicate directly with the Exchange server without a separate login procedure. In order to achieve a desired functionality of the display device, the display device is provided with a set of instructions that can be communicated to/from the Exchange server using the WebDAV interface. Consequently, the system can be seen as a system wherein WebDAV establishes a communication channel between display device and exchange server, and wherein the display devices and Exchange server are automatically authenticated to each other, that is, the Exchange server accepts that the display device is, in fact, the user it claims to be without requiring any additional login operation. Thereby, communication of relevant data can be accomplished in a simple manner without any login procedure.

Consequently, in this embodiment, all additional functionality required to obtain a system according to the present invention (apart from the user account) is contained in the display device, i.e. all functional algorithms that handle information exchange between the scheduling server and the display device, and the present invention thus provides for a scheduling system that is easy to install with minimum impact on the existing computer network.

The power supply requirement of the display device can be made relatively low, and in case the display device is connected to the computer network by means of a wired connection, the computer network can be utilized to power supply the display device. This solution thus has the advantage that there is no requirement of any power socket in the vicinity of the display device, and hence the location of the display device can be determined without the need to take power supply into consideration.

On the other hand, the network interface 301 of the display device can also be of a kind that supports wireless communication with the computer network, thereby enabling communication with the scheduling server over a wireless network. Such communication can be advantageous, e.g. at locations at which a wired connection is not available, impractical or undesired for other reasons.

So far, the invention has been described for implementation in a Microsoft Exchange Server environment. The invention is, however, applicable in any scheduling server environment in which a communication protocol fulfilling the requirements of the present invention can be used, i.e. a communication protocol by means of which the display device can be automatically authenticated by the scheduling server, so that communication between display device and scheduling server is allowed without the requirement of additional software on the scheduling server.

A schematic embodiment of the present invention for the general case is shown in FIG. 4. The display device is schematically indicated by 401, and includes, from a functional point-of-view, software 403 for carrying out the above described display of scheduling information, and for communicating with a scheduling server 402. The software 403, however, is not communicating directly with the scheduling server, but communicates, instead, with the communication protocol via an application programming interface (API) 404. The use of an API 404 has the advantage that the software portion 403 can remain substantially the same for display devices being used for different scheduling servers, since the API itself is largely abstract and in principle specifies an interface, e.g. a set of instructions such as “get reservation” for use by the software portion 403, while these instructions is then converted to a format suitable for the particular protocol 405, e.g. WebDAV, being used.

This also has the advantage that the requirements of the API can be specified in a manner such that APIs for different protocols can be provided by different providers. For example, Microsoft Exchange APIs provided by Independentsoft (www.independentsoft.com), such as the Independentsoft WebDAV Library, can be utilized when realizing the present invention in a Microsoft Exchange Server environment. The operating system of the display device, can, for example, be Windows CE or Windows XP Embedded or equivalents.

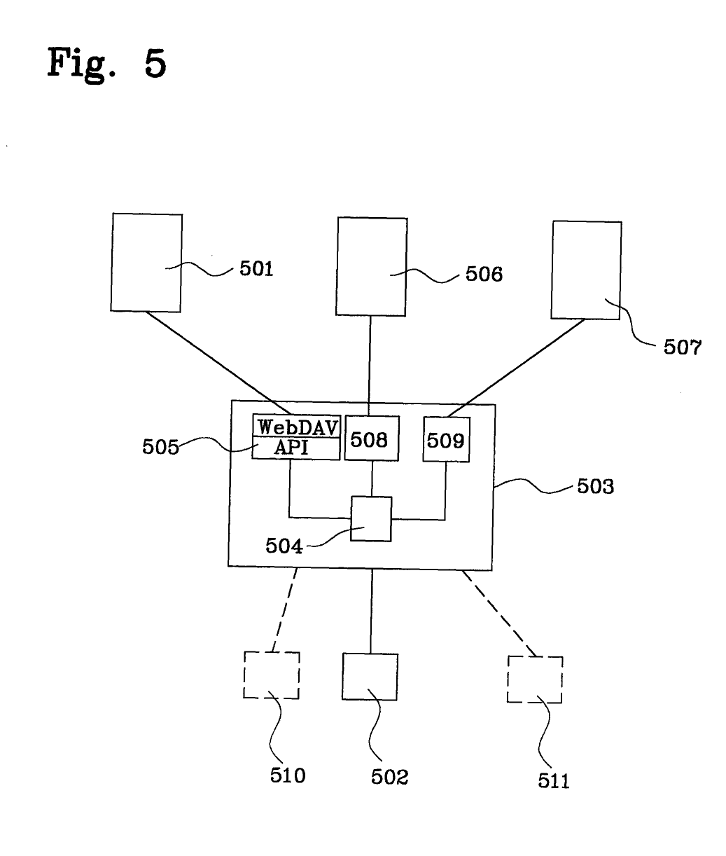

Hitherto, the invention has been described as having all functionality integrated in the display device. It is, however, also possible to utilize an intermediate server 503 on the computer network for communication with the scheduling server. In this case, the intermediate server runs a webservice 504 that functions as an intermediate layer between the scheduling server and the display device. An example of such a solution is disclosed in FIG. 5, and instead of communicating directly with the scheduling server 501, the display device 502 is communicating with the webservice 504 on the intermediate server 503. The intermediate server 503 then communicates with the scheduling server 501 using a protocol fulfilling the requirements according to the present invention, e.g. via an API 505 as above.

This solution has the advantage that the same display device can be used irrespective of which kind of scheduling server that is being used, since the interface towards the intermediate server can always remain the same since it is the intermediate server that handles the communication with the scheduling server. This embodiment also has the advantage that software of the display device, e.g., can be updated from the intermediate server, which is particularly advantageous if there are plural display devices 502, 510, 511 being connected to the intermediate server.

The webservice of the intermediate server can be also designed in such a way that it can be arranged to include means for communication with different APIs so as to allow communication with different kinds of scheduling servers, e.g. both Microsoft Exchange systems and “non-Exchange” systems should there be a need for such solution. This is exemplified by scheduling servers 506, 507 and associated APIs 508, 509.

This solution reduces demands on the hardware of the display device, since in this case the webservice contains all functional algorithms that handle information exchange between the scheduling server and the display device, and the display device only being required to display data provided by the webservice. Since the webservice is not located on the same physical server as the scheduling server, similar advantages as described above are obtained.

A single display device according to the present invention can also be utilized to display data with regard to more than one resource, e.g. if the resources are located such that the single display device can be arranged in proximity to the resources in a convenient manner. In this case, the display device can also be utilized by a user to make reservations according to the above in respect of all resources for which data is displayed, i.e. not only for the resource at which the display device is located.

The present invention has been exemplified with WebDAV above. It is, however, also contemplated that other protocols can be used as well, such as, e.g., Exchange Web Services (EWS). EWS is included in newer Microsoft Exchange Server editions. Consequently, similar to the WebDAV solution described above, no additional scheduling server installations are required for EWS based solutions, since the EWS software is already present in the scheduling server.

1. An information display system for displaying scheduling information regarding utilization of a resource, the information display system comprising at least one display device to be located in proximity to the said resource and including means for displaying scheduling information regarding the said resource, wherein the scheduling of the said resource is controlled by a scheduling server and wherein resource scheduling information is transmitted from the scheduling server over a computer network to the display device for being displayed on a display of the display device, characterized in that the information display system includes communication means for communication with the said scheduling server by means of a communication protocol by means of which communication protocol the information display system can be automatically authenticated by the said scheduling server, so as to allow communication of scheduling information between the information display system and the scheduling server independent of installation of additional software on the scheduling server.

2. Information display system according to claim 1, characterized in that the said display device includes means for communication with the said scheduling server using the said communication protocol.

3. Information display system according to claim 1, characterized in that the said system comprises a plurality of display devices including means for communication with the said scheduling server using the said communication protocol.

4. Information display system according to claim 1, characterized in that the system further comprises an intermediate server, and that the said intermediate server includes means for communication with the said scheduling server using the said communication protocol, and means for providing scheduling information obtained from the scheduling server to the display device.

5. Information display system according to claim 4, characterized in that the said intermediate server includes means for communication with the said scheduling server using the said communication protocol, and means for providing scheduling information obtained from the scheduling server to a plurality of display devices.

6. Information display system according to claim 4, characterized in that the intermediate server includes means for communication with at least two scheduling servers.

7. Information display system according to claim 4, characterized in that the intermediate server includes means for communication with at least two scheduling servers using different communication protocols.

8. Information display system according to claim 1, characterized in that the display device is arranged to display data with regard to more than one resource.

9. Information display system according to claim 8, characterized in that the system is arranged such that the display device can be utilized by a user to perform reservations with regard to said more than one resource.

10. Information display system according to claim 1, characterized in that the display device is provided with an indicator so as to allow determination of room availability from a distance.

11. Information display system according to claim 1, characterized in that the said scheduling server is a Microsoft Exchange Server.

12. Information display system according to claim 1, characterized in that the said communication protocol for use in communication between the information display system and the scheduling server is a Web-based Distributed Authoring and Versioning (WebDAV) based protocol, and/or Exchange Web Services (EWS) based protocol.

13. Information display system according to claim 1, characterized in that the display device is arranged to display name/identity of the person responsible for, and/or the subject of, a reservation of a scheduled resource.

14. Information display system according to claim 1, characterized in that the system comprises means for setting which data that is to be displayed by a display device, so as to allow different display devices to display different data.

15. Information display system according to claim 1, characterized in that, when it has not been confirmed that scheduled utilization of a resource has commenced, the system is arranged to automatically cancel scheduling information regarding the said utilization of the resource when a first time has elapsed since the utilization was to commence.

16. Information display system according to claim 1, characterized in that the display device is arranged to activate features of a resource prior to or at the time utilization of a scheduled resource is to commence.

17. A display device for use in a scheduling system according to claim 1, characterized in that the display device comprises a display for displaying scheduling information regarding utilization of a resource, wherein scheduling of the said resource is controlled by a scheduling server, the display device further including communication means for communication with the said scheduling server by means of a communication protocol by means of which communication protocol the display device can be automatically authenticated by the said scheduling server, so as to allow communication of scheduling information between the display device and the scheduling server independent of installation of additional software on the scheduling server.

18. Method for displaying scheduling information regarding utilization of a resource, wherein at least one display device is located in proximity to the said resource and including means for displaying scheduling information regarding the said resource, wherein the scheduling of the said resource is controlled by a scheduling server and wherein resource scheduling information is transmitted from the scheduling server over a computer network to the display device for being displayed on a display of the display device, the method further including the step of:
communicating with the said scheduling server by means of a communication protocol by means of which communication protocol the information display system can be automatically authenticated by the said scheduling server, so as to allow communication of scheduling information independent of installation of additional software on the scheduling server.
